(19) United States
(12) Patent Application Publication
(10) Pub. No.: US 2026/0127795 A1
(43) Pub. Date: May 7, 2026

(54) GENERALIZED PATCH-BASED INFERENCE FOR DENOISING DIFFUSION MODELS FOR PLUG-AND-PLAY MEDICAL IMAGE RESTORATION/RECONSTRUCTION

(71) Applicant: Siemens Healthineers AG, Forchheim (DE)

(72) Inventors: Saikat Roy, Heidelberg (DE); Mahmoud Mostapha, Princeton, NJ (US); Radu Miron, Iasi (RO); Mariappan S. Nadar, Plainsboro, NJ (US); Matthew Holbrook, Pennington, NJ (US)

(21) Appl. No.: 19/090,989

(22) Filed: Mar. 26, 2025

Related U.S. Application Data
(60) Provisional application No. 63/716,749, filed on Nov. 6, 2024.

(30) Foreign Application Priority Data
Nov. 6, 2024 (EP) 24465590.8

(51) Int. Cl. G06T 11/00; G06T 5/60; G06T 5/70

(52) U.S. Cl. CPC G06T 12/20; G06T 5/60; G06T 5/70; G06T 2207/10088; G06T 2207/20081; G06T 2207/30016; G06T 2207/30081

(57) ABSTRACT

Systems and methods for image reconstruction that uses patch-based processing of images during each evaluation for inverse problems, while remaining independent of specialized neural network architectures or specialized training of a diffusion prior. Embodiments use a grid sampling strategy to determine patches that includes a shifted-grid approach and a reflective padding approach in order to avoid artifacts in the resulting estimations.

### CROSS REFERENCE TO RELATED APPLICATIONS

This application claims priority to U.S. provisional application Ser. No. 63/716,749, filed Nov. 6, 2024, and European Patent Application EP24465590.8, filed Nov. 6, 2024, both of which are entirely incorporated by reference.

### FIELD

This disclosure relates to medical imaging.

### BACKGROUND

Magnetic resonance imaging, or MRI, is a noninvasive medical imaging test that can generate detailed images of almost every internal structure in the human body, including, for example organs, bones, muscles, and blood vessels. The process of transforming the acquired MRI data to images is called image reconstruction. Image reconstruction transforms the data into interpretable images using signal processing techniques to improve image quality and speed up scans.

Deep learning-based approaches have been proposed that use neural networks to enhance image reconstruction, improving speed and accuracy. For example, plug-and-play approaches to solving inverse problems in complex MRI data have recently benefitted from Diffusion-based generative priors. In such a scheme, a diffusion model is used to model the prior distribution and may be used in a number of inverse tasks such as denoising or super-resolution without the need to train individual models for each task. This has led to exceptional performance of such diffusion based inverse solvers in CT or complex MRI data while retaining perceptual quality and reconstruction faithfulness. In the context diffusion models, Neural Function Evaluations (NFEs) refer to the number of times the underlying neural network, which parametrizes the system dynamics, is evaluated during the numerical integration of the ODE solver. Existing diffusion models process the entire image at once during each NFE, necessitating large amounts of GPU memory. This can quickly become infeasible in images with large resolutions.

### SUMMARY

By way of introduction, the preferred embodiments described below include methods, systems, instructions, and/or computer readable media for generalized patch-based inference for denoising diffusion models for plug-and-play medical image restoration/reconstruction.

In a first aspect, a method for image reconstruction of medical imaging data, the method comprising: acquiring a medical image of a patient; iteratively refining the medical image using a diffusion PnP model comprising a plurality of iterations, wherein for each iteration of the plurality of iterations, predictions for the medical image occur on a set of patches sampled from a grid of the medical image; and outputting the refined medical image, wherein the patches are sampled using shifting-grid-based patch sampling to resolve grid artifacts, wherein reflection padding is used on the patches sampled from the grid to eliminate foreground-to-padded-background transitions.

In a second aspect, a system for image reconstruction of medical imaging data, the system comprising: a medical imaging system configured to acquire medical imaging data; a diffusion PnP model configured to use patch-based sampling to reconstruct a medical image from the medical imaging data, wherein instead of predicting an entire denoised image, predictions occur on foreground patches sampled from a grid; and an interface configured to display the medical image.

In a third aspect, a method for image reconstruction of a medical image, the method comprising: acquiring medical imaging data of a patient; iteratively refining the medical imaging data using a diffusion PnP model, wherein each iteration comprises: dividing the medical imaging data into a first set of patches using a grid, wherein reflection padding mirrors pixel values at image boundaries of the medical image; performing inference on one or more patches from the first set using a trained generalized diffusion prior; dividing the medical imaging data into a second set of patches using a second grid, the second grid shifted from the first grid, wherein reflection padding mirrors pixel values at image boundaries of the medical image; performing inference on one or more patches from the second set using a trained generalized diffusion prior; reincorporating the medical imaging data from the patches from the first set and second set for which inference was performed, the reincorporated medical imaging data uses to solve a data proximal subproblem for regularization; deriving a state for a next iteration by adding noise back; and outputting the refined medical imaging data.

Any one or more of the aspects described above may be used alone or in combination. These and other aspects, features and advantages will become apparent from the following detailed description of preferred embodiments, which is to be read in connection with the accompanying drawings. The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the embodiments. Moreover, in the figures, like reference numerals designate corresponding parts throughout the different views.

FIG. 1 depicts an example MRI system for generalized patch-based inference for denoising diffusion models for plug-and-play medical image restoration/reconstruction.

FIG. 2 depicts an example of a generative diffusion process.

FIG. 3 depicts an example method for generalized patch-based inference for denoising diffusion models for plug-and-play medical image restoration/reconstruction according to an embodiment.

FIG. 4 depicts an example step for reconstruction of medical imaging data using diffusion according to an embodiment.

FIG. 5 depicts an example of a shifting grid according to an embodiment.

FIG. 6 depicts examples of input, denoised, and target images according to an embodiment.

FIG. 7 depicts an example of memory usage compared with input resolution according to an embodiment.

FIG. 8 depicts an example system for generalized patch-based inference for denoising diffusion models for plug-and-play medical image restoration/reconstruction.

FIG. 9 depicts an example U-net architecture.

FIG. 10 depicts an example artificial neural network.

FIG. 11 depicts an example convolutional neural network.

FIG. 12 depicts an example method for training a diffusion model for medical image restoration/reconstruction.

### DETAILED DESCRIPTION

Embodiments described herein provide systems and methods that use patch-based processing of images during each evaluation for inverse problems, while remaining independent of specialized neural network architectures or specialized training of the diffusion prior. Embodiments use a grid sampling strategy to determine patches that includes a shifted-grid approach and a reflective padding approach in order to avoid artifacts in the resulting estimations.

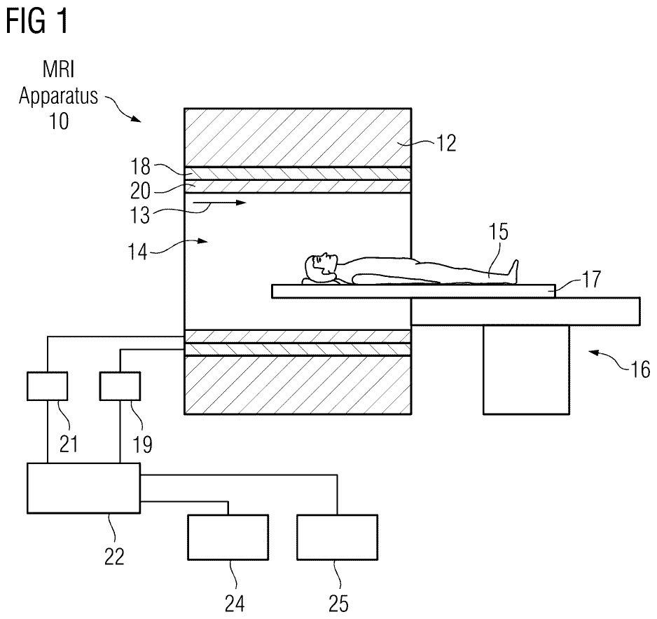

FIG. 1 depicts an example magnetic resonance apparatus 10. The magnetic resonance apparatus 10 includes a magnetic unit 11 that includes a main magnet 12 for the generation of a main magnetic field 13. In addition, the magnetic resonance apparatus 10 includes a patient receiving area 14 for receiving a patient 15. The patient receiving area 14 may be cylindrical in design and cylindrically surrounded by the magnetic unit 11 in a circumferential direction. Different designs of the patient receiving area 14 may be used. The patient 15 may be pushed into the patient receiving area 14 by a patient positioning device 16 of the magnetic resonance apparatus 10. The patient positioning device 16 includes a patient table 17 for this purpose that is configured to be movable within the patient receiving area 14.

The magnetic unit 11 also includes a gradient coil unit 18 for the generation of gradient pulses that are used for location coding during imaging. The gradient coil unit 18 is controlled by a gradient control unit 19 of the magnetic resonance apparatus 10. The magnetic unit 11 also includes a radio frequency antenna unit 20, that may be configured as a body coil permanently integrated into the magnetic resonance apparatus 10. The radio frequency antenna unit 20 is controlled by a radio frequency antenna control unit 21 of the magnetic resonance apparatus 10 and emits RF transmission pulses into an examination area during a magnetic resonance measurement, that is essentially formed by a patient receiving area 14 of the magnetic resonance apparatus 10. As a result, the main magnet field 13 generated by the main magnet 12 is excited by atomic nuclei. Magnetic resonance signals are generated by relaxation of the excited atomic nuclei. The radio frequency antenna unit 20 is configured to receive magnetic resonance signals.

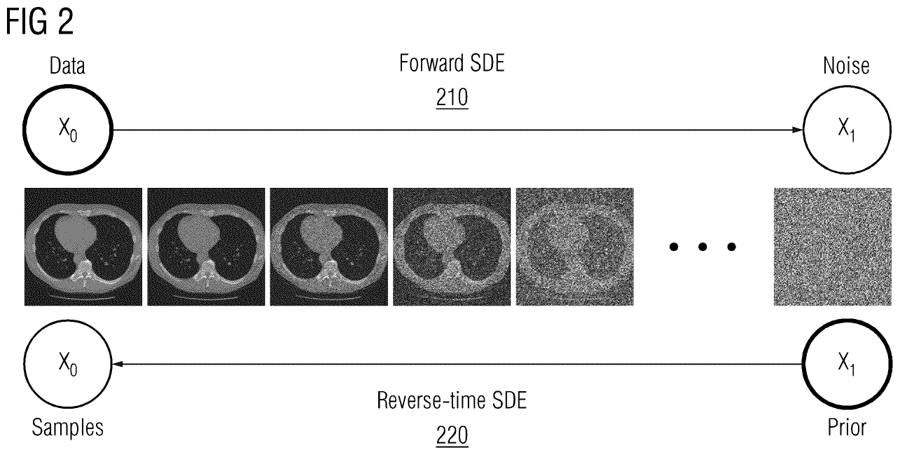

The magnetic resonance apparatus 10 has a system control unit 22 for controlling the main magnet 12, the gradient control unit 19 and for controlling the radio frequency antenna control unit 21. The system control unit 22 centrally controls the magnetic resonance apparatus 10, such as, for example, performing a predetermined imaging magnetic resonance measurement. The system control unit 22 is configured to execute a computer-implemented method for performing a magnetic resonance, as shown in FIG. 2.

In addition, the system control unit 22 includes an evaluation unit not shown in more detail for evaluating the magnetic resonance signals that are recorded during the magnetic resonance examination. Furthermore, the magnetic resonance apparatus 10 includes a user interface 23 that is connected to the system control unit 22. Control information such as, for example imaging parameters, as well as reconstructed magnetic resonance images may be displayed on a display unit 24, for example on at least one monitor, the user interface 23 for a medical operator. Furthermore, the user interface 23 has an input unit 25 by which information and/or parameters may be entered by the medical operator during a measurement process. During an imaging procedure, the magnetic resonance apparatus 10 is configured by the imaging protocol to scan a region of a patient 15. The system control unit 22 is configured to reconstruct an image using the acquired MRI data from the imaging procedure. Image reconstruction may be performed by the system 10, system control unit 22, or other computing devices. Image reconstruction is the process of converting raw data from an imaging scan into a clinical image. Image reconstruction is a critical step in the MRI process, as the quality of the reconstructed image can affect the accuracy of the diagnosis. The system control unit 22 may also be configured for refinement or restoration of an image (for example denoising or super resolution). Noisy and/or inaccurate images may be difficult to interpret and may result in poor diagnoses and clinical outcomes.

In embodiments described herein, image reconstruction/restoration uses a generative deep learning framework, for example diffusion model(s), for reconstructing and/or restoring images from acquired imaging data. The generative deep learning model utilizes prior knowledge either with (supervised) or without (unsupervised) knowledge of a specific reconstruction task. By decoupling learning of the prior knowledge from the reconstruction task, the diffusion models may overcome existing issues of costly training and poor robustness to varied scan parameters. Inverse imaging problems-such as image reconstruction, super-resolution, and image deblurring-require algorithms to estimate clear, detailed images from incomplete, noisy, or otherwise degraded data.

FIG. 2 depicts an example of a generative diffusion process for image processing including the forward process 210 and the reverse process 220 (also referred to as the inference stage). The goal of the diffusion model is to learn the diffusion process for a given dataset, such that the process can generate new elements that are distributed similarly as the original dataset. In the forward stochastic differential equation (SDE) noise is added to the input image over and over again until the image is practically all noise. At each step, the diffusion model learns how to map images to their corresponding noise-free measurements. In the reverse step, the learned diffusion model is used to recover the data by reversing this noising process. Image reconstruction in MRI is a similar inverse problem that attempts to find an image from noisy scan measurements. To solve the inverse problem a forward model is defined that maps noisy MR images to their corresponding noise-free measurements. As measurements become noisier (for example as scan time is reduced) or less complete (for example when using increased acceleration), the resulting image reconstruction problem becomes highly ill-posed, meaning it has no stable, unique solution. In such situations the acquired measurements are said to be sparse, i.e., they are generally insufficient to uniquely specify a finite-dimensional approximation of the sought-after object, even in the absence of measurement noise or errors related to modeling the imaging system. False structures may arise due to the reconstruction method incorrectly estimating parts of the object that either did not contribute to the observed measurement data or cannot be recovered in a stable manner, a phenomenon that is referred to as hallucinations. Hallucinations may be resolved by incorporating information about the distribution of probable images, so-called prior knowledge. The reconstructed image balances maximizing both the likelihood that explains measurements, and the prior, that is, the probability that is a valid medical image. In embodiments described herein, the diffusion models capture rich image priors from underlying data distributions. From a Bayesian perspective, the diffusion models learn the a priori probability density function of the images. Solving the Bayesian inverse problem is tantamount to drawing posterior samples (and/or computing the posterior mean) from the posterior density function that is a product of the likelihood function (physical and statistical model of the imaging system) and the learnt a priori probability density function.

Inverse solvers such as Diffusion Posterior Sampling (DPS) or Denoising Diffusion Models for Plug-and-Play Image Restoration (DiffPIR) have primarily focused on processing the entire image at once (otherwise known as full-resolution inference) with the deep diffusion prior, for inverse problems such as denoising and super-resolution. However, the processing of the full image necessitates high memory utilization and may be infeasible for high-resolution images. Another method referred to as Patch-based Position-Aware Diffusion Inverse Solver (PaDIS) has attempted to solve this issue by using patch-based diffusion models. PaDIS operates by setting a grid and processing individual patches. In order to issues, PaDIS adds extra padding to the image to accommodate a grid larger than the image to sample patches for NFEs. In PaDIS, the main principle is that the grid is regenerated each time a NFE occurs during the reverse diffusion process. Training with position-encoded patches allows PaDIS's diffusion model to learn complex, detailed image priors efficiently. During training, PaDIS uses these encoded patches to capture both fine-grained local detail and broader spatial relationships within the original images. At inference time, PaDIS systematically assembles predicted patches into complete images by leveraging their positional encodings. This reconstruction process integrates local information into globally consistent images. However, this process results in a constantly shifting grid at various steps of the inverse diffusion process that does not allow for sharp edge-based artifacts when the patches are stitched back to obtain the full resolution image.

Embodiments described herein provide patch-based inference in the inverse solutions of the image restoration/reconstruction using a underlying grid sampling strategy that provides efficiency and portability. Neural Function Evaluations (NFEs) of sub-regions of the input image (or patches) are used. The full image is then stitched back together without artifacts. In an embodiment, grid artifacts are resolved by application of shifting-grid-based patch sampling. In addition, foreground to background boundary transition artifacts are resolved using reflection padding. Foreground to background boundary artifacts occur during sharp transitions between foreground and background introduced by the padding to enable the shifting grid patch sampling. To enable generic usage of the sampling, reflection padding is used instead of zero-padding to eliminate these foreground-to-padded-background transitions, thus eliminating these artifacts. The resultant method may be applied to any diffusion based inverse solver without the necessity of any special training or architectural changes. The methods provide an underlying grid sampling for an algorithm which functions independent of neural network architectures, inverse solvers or tasks. The method may be generically applicable irrespective of modalities such complex MRI data or CT, photon counting CT (PCCT), ultra-high-resolution CT (UHR PCCT) and spectral CT. This is also valid for data dimensionality such as 2D, 3D, or n-Dimensional input data.

In an embodiment, a shifted-grid approach is used that builds up previously introduced methods like Patch-based position-aware Diffusion Inverse Solver (PaDIS). The core idea is to perform inference on smaller patches rather than whole images. This patch-based technique enables the model to process images more efficiently and minimize visible artifacts that arise when stitching patches—particularly at boundaries—by smoothing transitions through strategic positioning of the patches. By employing this approach, embodiments can seamlessly integrate with various existing inverse solvers without requiring significant alterations or positional embeddings, making it flexible and broadly applicable.

Embodiments described herein provide a decrease in memory consumption while providing equal to superior performance. For example, a reduction in memory overhead of approximately 25% may be provided when employing 128×128 patches against the original whole image resolution of up to 320×320.

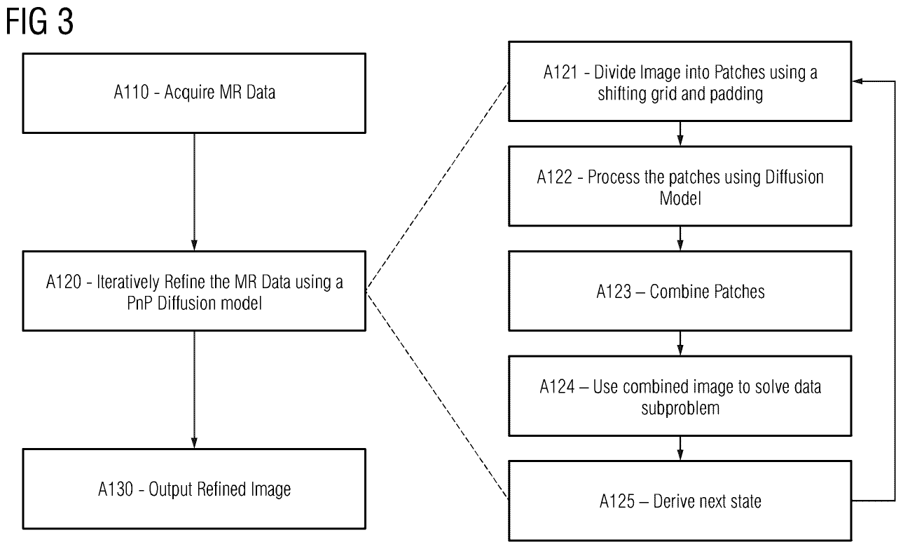

FIG. 3 depicts an example method for generalized patch-based inference for denoising Diffusion Models 200 for plug-and-play medical image restoration/reconstruction. The method is performed by the system of FIG. 1 or another system. The method is performed in the order shown or other orders. Additional, different, or fewer acts may be provided.

At act A110, medical image of a patient 15 is acquired. The medical image may be acquired using an MRI scanning system such as describe in FIG. 1. Alternatively, the medical image may be provided from another source such as a database or previous scan. The medical imaging data may be acquired using an accelerated sequence. In an embodiment, an MRI system 100 acquires k-space measurements that are used to generate an initial reconstructed image that is input into the reconstruction/refinement process as described below.

At act A120, the medical image is iteratively refined using a diffusion PnP process comprising a plurality of iterations, wherein for each iteration of the plurality of iterations, predictions for the medical image occur on a set of patches sampled from a grid 301 of the medical image. In an embodiment, a pretrained diffusion model is used to remove noise to predict a next state of the iterative process and measurement data (G) is incorporated by solving a data proximal subproblem, the measurement data (G) applied to the next state to ensure consistency. The diffusion PnP model may include measurement during reverse diffusion steps, which is based on DDIM and supports fast sampling. This measurement may be carried out after a correction step that accounts for the inaccurate estimation resulting from computing the proximal solution. As a result of this process, the medical images are restored/refined to improve the quality of the images by mitigating noise, artifacts, or missing data.

In an embodiment, the diffusion model may be or may be adapted from a Denoising Diffusion Implicit Model (DDIM). The proposed diffusion PnP includes measurement data for data consistency during reverse diffusion steps, which is based on DDIM and supports fast sampling. In the reverse process 210, an image is generated using the learned probability density function of contrast weighted MR image data while being constrained by a data consistency term G that represents expected/known measurements. The measurement data (G) may include measurements/linear transform of known features of the region or objects being scanned. For example, the measurement data (G) may include a ratio of the sizes or distances of or between two different features. This measurement is carried out after a correction step that accounts for the inaccurate estimation resulting from computing the proximal solution. The measurement data (G) is incorporated by solving the data proximal subproblem, for example using:

$${f}_{0}^{( t )} \text{?} = arg {min}_{f} {‖ G - [ H ] f ‖}^{2} + {p}_{t} {‖ f - {f}_{0}^{( t )} ‖}^{2} \qquad EQUATION 1$$

$$\text{?} \text{indicates text missing or illegible when filed}$$

Instead of processing the whole image at each iteration, embodiments use patch-based inference for reconstructing images from incomplete, noisy, or degraded data. In particular, embodiments process small, localized portions (patches) of an image independently, rather than treating the entire image simultaneously. In an embodiment, for patch-based inference, during each of the iterations, at Act A121, the image is first divided into smaller, overlapping patches defined, for example, by a grid 301. These patches may be configured squares or rectangles, such as 128×128 pixels in size, and overlap each other slightly to ensure seamless integration and reduce artifacts at the patch boundaries. During the inference stage, at Act A122, each individual patch is processed independently by the trained diffusion model. This processing involves using the diffusion prior (a learned statistical representation of the underlying image structure) to infer missing information, remove noise, enhance resolution, or otherwise reconstruct or improve the patch. After processing the individual patches separately, the resulting reconstructed patches are recombined (A123) into a complete, coherent image which is used to solve (A124) the data subproblem in the diffusion model. Noise is added to derive (A125) the next state which is used as the starting point of the next iteration.

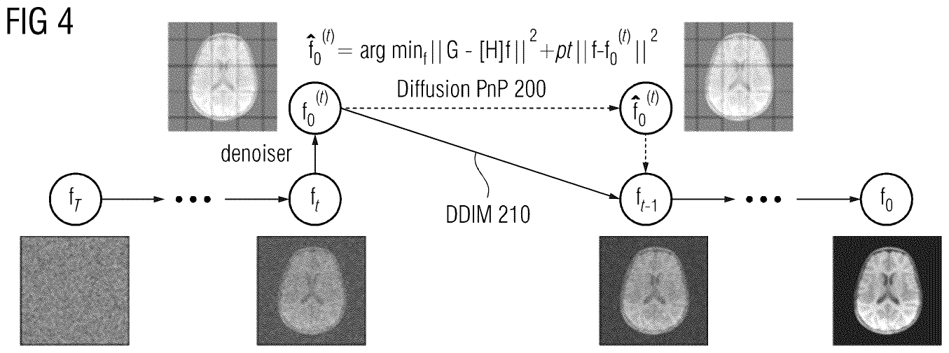

FIG. 4 depicts an example flowchart for generalized patch-based inference for denoising Diffusion Models 200 for plug-and-play medical image restoration/reconstruction. In an embodiment, for the inference process, a shifted-grid 301 approach is used. The shifted-grid 301 approach includes processing overlapping patches of the image to mitigate artifacts that can occur at the boundaries when the patches are naively stitched together. Predictions occur on foreground patches sampled from the grid 301. Subsequently, the denoised image is reincorporated from the patches and used to solve the data proximal subproblem. Then, the next state is derived by adding noise back, completing one step of the reverse diffusion sampling.

For step A121, the image is divided into smaller patches. In an example, the shifting-grid 301-based sampling method operates by first dividing the image into overlapping patches arranged on a regular grid. Unlike standard fixed-grid methods, which sample patches at fixed, non-overlapping intervals, shifting-grid 301 sampling systematically shifts the grid 301 by small offsets in multiple iterations. With each shift, a slightly different set of overlapping patches is extracted and processed. For instance, the first iteration may sample patches aligned exactly at certain intervals (e.g., every 128 pixels). Subsequent iterations shift the grid 301 by a fraction of the patch size (such as 32 or 64 pixels) in horizontal or vertical directions, producing a new set of overlapping patches.

For step A122, each set of shifted patches may be independently processed by the diffusion model or reconstruction algorithm, generating a separate estimate of the image. After processing patches from multiple shifted grids, these reconstructions are aggregate, for example by averaging the overlapping regions, to produce an estimated image that is used in to solve the subproblem for the diffusion model described in Equation 1. Because each pixel region in the final image is reconstructed multiple times from slightly shifted positions, boundary artifacts and discontinuities become less prominent. The overlapping reconstructions effectively smooth out inconsistencies, ensuring a seamless, coherent appearance in the final combined image.

In addition, one challenge in patch-based inference is the occurrence of artifacts at the transitions between foreground and background regions, especially when zero-padding is used. Embodiments use reflection-padding instead of zero-padding to avoid such artifacts, resulting in cleaner and more accurate image reconstructions. Reflection padding is a technique used in image processing to manage edge effects when dividing images into patches or when applying convolutional filters. Reflection padding addresses this issue by replicating pixels adjacent to the border, mirroring them outwardly. Thus, pixels near the boundary of the image are symmetrically reflected, creating a seamless transition at the edges. Thes mirrored reflection avoids introducing unnatural artifacts and abrupt transitions, which frequently occur with simpler methods like zero-padding, where zeros artificially create sharp issues.

In an embodiment, Neural Function Evaluations (NFEs) of the sub-regions of the input image (or patches) are independently applied. The full image back may then stitched together without artifacts. The underlying grid sampling is customized to obtain an algorithm which functions independent of neural network architectures, inverse solvers or tasks.

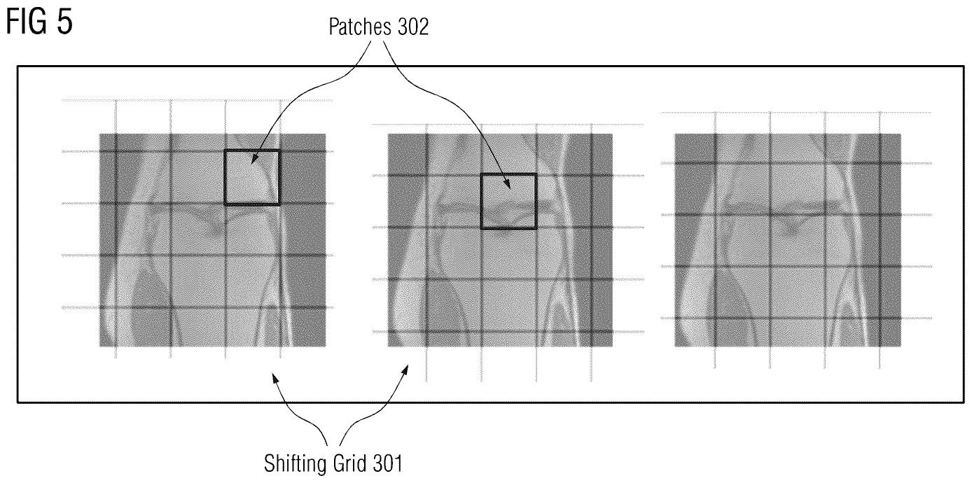

FIG. 5 depicts an example of sampled patches 302 during one NFE. Due to the shifting grid 301, patches 302 sampled during one NFE in the inverse diffusion process do not resemble previous or subsequent ones, thus smoothing and allowing no sharp edges in the full resolution image when the patches 302 are reconstituted back together, resulting in a final image free from grid artifacts. FIG. 5 depicts three different grids 301 that have been shifted from one another. The resulting patches 302 generated by different grids thus overlap one another.

The iterative reverse process includes a plurality of steps. In an embodiment, the algorithm uses DDPM for the diffusion model. In an embodiment, in the reverse process, sampling is adapted from Deep Diffusion Implicit Models (DDIM). DDIM accelerates the sampling process of Diffusion Models 200 by using non-Markovian diffusion processes. This approach allows for faster generation of high-quality images while maintaining the same training objective as traditional Diffusion Models 200. Implicit models focus on representing functions implicitly rather than explicitly. Instead of defining a mathematical formula directly, the implicit model defines a set of equations that describe the relationship between inputs and outputs without specifying the exact function.

The sampling process in DDIM involves sampling from the prior distribution and then iteratively sampling from the conditional distributions. This process is faster than traditional diffusion models 200 because it does not require simulating the entire Markov chain. The number of NFEs, e.g. the total number of times the neural network needs to be called during the sampling process to generate a new image, is typically significantly lower in a DDIM compared to a standard DDPMs due to DDIM's more efficient non-Markovian diffusion process, resulting in faster generation times with fewer computations required. For example, fewer than 50 or 100 NFEs may be required to provide an acceptable output.

In an embodiment, a quadratic sampling technique is used. Sampling involves iteratively refining an image from a noisy initialization by stepping backward through a predefined sequence of time steps. The choice of these steps significantly impacts the efficiency and quality of image reconstruction. In a quadratic sampling scheme, the time steps are spaced according to a quadratic function, meaning the interval between successive steps increases quadratically as the sampling process progresses. This contrasts with uniform or geometric schedules, where the time steps are either equally spaced or decrease exponentially. The quadratic approach provides finer resolution in the early stages of denoising, when large noise components must be accurately removed, while allowing larger steps in later stages when the image structure has already stabilized. The use of this approach ensures that the early steps focus more on fine-grained denoising while later steps consolidate the reconstructed image. Different sampling techniques within diffusion models 200, like DPM-Solver or optimized ODE solvers, may also be used to adjust the required NFE.

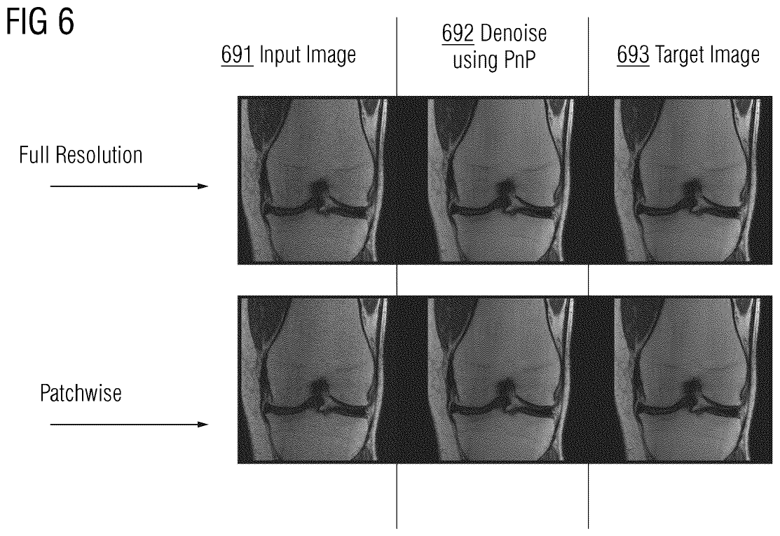

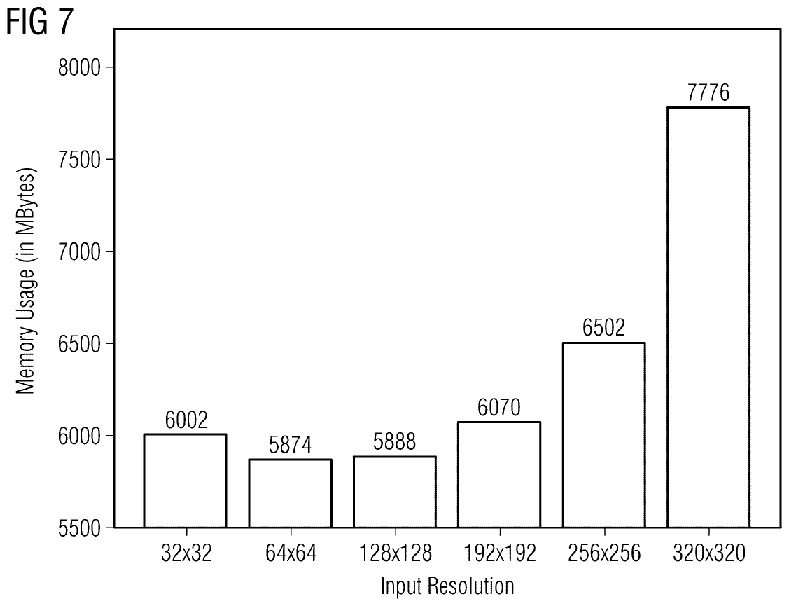

At the end of the iterative process, the model has estimated a refined/reconstructed/restored image. At act A130, the refined medical image is output. FIG. 6 depicts several example of full resolution interference and patchwise interference images. FIG. 6 depicts input images 691, output images 692 generated using a denoising PnP, and target images 693. The patchwise interference provided on the bottom row provides similar to better results than the full resolution interference provided on the top row while requiring less memory and processing power. FIG. 7, for example, depicts results of several different input resolutions and how memory usage is diminished by using patchwise interference as described in FIG. 3. A patch size of 128×128 reduces memory consumption by almost 2 GBytes compared to inference on an image of size 320×320.

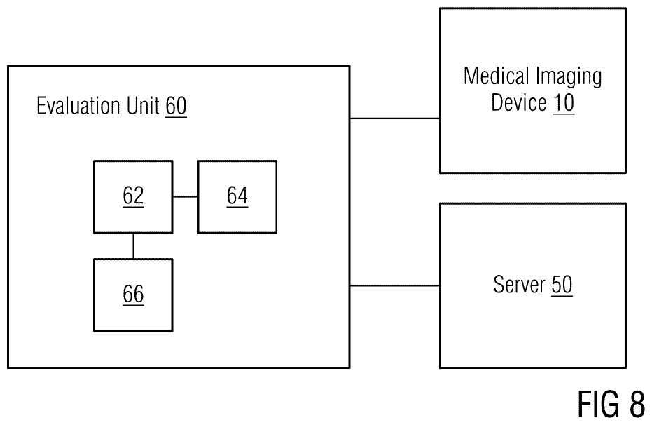

FIG. 8 depicts a system that uses patch-based processing of images during each evaluation for inverse problems. The system includes an evaluation unit 60, a medical imaging device 10, and a server 50. The Evaluation unit may be part of the control unit 22, e.g. part of the MRI apparatus 10, or may be a separate processing unit. In an embodiment, the medical imaging device is a MR imaging device 10, for example, as described above in FIG. 1. The MR system 10 of FIG. 1 includes an MR scanner or system, a computer, or other system. The MR imaging device 10 is only exemplary, and a variety of MR scanning systems may be used to collect the MR data. The MR imaging device 10 (also referred to as a MR scanner or image scanner) is configured to scan a patient 15. The MR imaging device 10 scans a patient 15 to provide k-space measurements (measurements in the frequency domain).

The processor 62 of the evaluation unit 60 may include an image processor that generates images using a machine learning network (machine learning model). The image processor is a general processor, digital signal processor, three-dimensional data processor, graphics processing unit, application specific integrated circuit, field programmable gate array, artificial intelligence processor, digital circuit, analog circuit, combinations thereof, or another now known or later developed device for image generation. The image processor is a single device, a plurality of devices, or a network. For more than one device, parallel or sequential division of processing may be used. Different devices making up the image processor may perform different functions. In one embodiment, the image processor is also a control processor or other processor of the imaging device. Other image processors of the imaging device or external to the imaging device may be used. The image processor is configured by software, firmware, and/or hardware to process the data acquired by the imaging device and output one or more images.

The instructions for implementing the processes, methods, and/or techniques discussed herein are provided on non-transitory computer-readable storage media or memories, such as a cache, buffer, RAM, removable media, hard drive, or other computer readable storage media, for example the memory. The instructions are executable by the processor or another processor. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the instructions set, storage media, processor or processing strategy and may be performed by software, hardware, integrated circuits, firmware, micro code, and the like, operating alone or in combination. In one embodiment, the instructions are stored on a removable media device for reading by local or remote systems. In other embodiments, the instructions are stored in a remote location for transfer through a computer network. In yet other embodiments, the instructions are stored within a given computer, CPU, GPU, or system. Because some of the constituent system components and method steps depicted in the accompanying figures may be implemented in software, the actual connections between the system components (or the process steps) may differ depending upon the manner in which the present embodiments are programmed.

In an embodiment, the processor 62 is configured to implement patch-based inference in inverse solutions, including Neural Function Evaluations (NFEs) of sub-regions of the input image (or patches) and stitching the full image back together without artifacts. The processor 62 implements the underlying grid 301 sampling to obtain an algorithm which functions independent of neural network architectures, inverse solvers or tasks. The algorithm is generically applicable irrespective of modalities such complex MRI data or CT, photon counting CT (PCCT), ultra-high-resolution CT (UHR PCCT) and spectral CT. This is also valid for data dimensionality such as 2D, 3D or n-Dimensional input data. The processor 62 implements a process that resolves different types of artifacts during this process of using patch-based inference. Grid artifacts are resolved by application of shifting-grid-based patch sampling. Foreground to Background boundary artifacts occur during sharp transitions between foreground and background introduced by the padding to enable the shifting grid 301 patch sampling. To enable generic usage of the sampling, reflection padding is used instead of zero-padding to eliminate these foreground-to-padded-background transitions, thus eliminating these artifacts. The resultant algorithm fits simply on top of any Diffusion based inverse solver, without the necessity of any special training or architectural changes.

In an embodiment, the processor 62 is configured to divide the medical imaging data into a first set of patches using a grid 301, wherein reflection padding mirrors pixel values at image boundaries of the medical image; perform inference on one or more patches from the first set using a trained generalized diffusion prior; divide the medical imaging data into a second set of patches using a second grid 301, the second grid 301 shifted from the first grid 301, wherein reflection padding mirrors pixel values at image boundaries of the medical image; perform inference on one or more patches from the second set using a trained generalized diffusion prior; reincorporate the medical imaging data from the patches from the first set and second set for which inference was performed, the reincorporated medical imaging data uses to solve a data proximal subproblem for regularization; and derive a state for a next iteration by adding noise back. In an embodiment, the patches from the first set overlap at least partially with patches from the second set. For example, by shifting the grid, the patches do not cover the same respective pixels and thus overlap with patches from patches from different grids.

In an embodiment, the processor 62 implements one or more machine learning networks that are stored in the memory. In general, a trained machine learning network mimics cognitive functions that humans associate with other human minds. In particular, by training based on training data the machine learning network is able to adapt to new circumstances and to detect and extrapolate patterns. Another term for “trained machine learning network” is “trained function”. In general, parameters of a machine learning network can be adapted by means of training. In particular, supervised training, semi-supervised training, unsupervised training, reinforcement learning and/or active learning can be used. Furthermore, representation learning (an alternative term is “feature learning”) can be used. In particular, the parameters of the machine learning networks can be adapted iteratively by several steps of training. In particular, within the training a certain cost function can be minimized. In particular, within the training of a neural network the backpropagation algorithm can be used. In particular, a machine learning network may comprise a neural network, a support vector machine, a decision tree and/or a Bayesian network, and/or the machine learning network can be based on k-means clustering, Q-learning, genetic algorithms, and/or association rules. In particular, a neural network can be a deep neural network, a convolutional neural network, or a convolutional deep neural network. Furthermore, a neural network can be an adversarial network, a deep adversarial network, and/or a generative adversarial network.

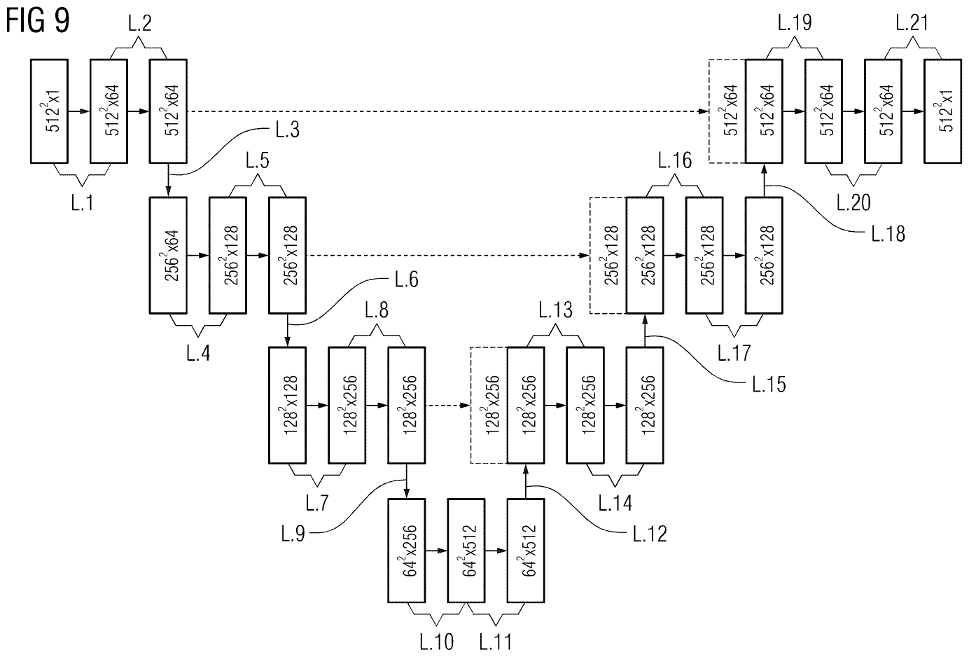

In an embodiment, the processor 62 implements a diffusion process for training and configuring the model using a patchwise sampling strategy. The diffusion process includes forward diffusion and reverse diffusion. Forward diffusion is used to add noise to the input image using a schedule which determines how much noise is added at the given step t. Reverse diffusion consists of multiple steps in which a small amount of noise is removed at every step. In an embodiment, the diffusion model is based on is a convolutional neural network, in particular, a convolutional neural network having a U-net structure, for example as displayed in FIG. 9. In FIG. 9, the input data to the machine learning network is a two-dimensional medical image comprising 512×512 pixel, every pixel comprising one intensity value. The machine learning network comprises convolutional layers (indicated by solid, horizontal arrows), pooling layers (indicating by solid arrows pointing down), and upsampling layers (indicated by solid arrows pointing up), the number of the respective nodes is indicated within the boxes. Within the U-net structure first the input images are downsampled (decreasing the size of the images and increasing the number of channels), afterwards they are upsampled (increasing the size of the images and decreasing the number of channels) to generate a transformed image.

All except the last convolutional layers L.1, L.2, L.4, L.5, L.7, L.8, L.10, L.11, L.13, L.14, L.16, L.17, L.19, L.20 use 3×3 kernels with a padding of 1, the ReLU activation function, and a number of filters/convolutional kernels that matches the number of channels of the respective node layers as indicated in FIG. 9. The last convolutional layer L.21 uses a 1×1 kernel with no padding and the ReLU activation function.

The pooling layers L.3, L.6, L.9 are max-pooling layers, replacing four neighboring nodes with only one node, the value being the maximum of the values of the four neighboring nodes. The upsampling layers L.12, L.15, L.18 are transposed convolution layers with 3×3 kernels and stride 2, which effectively quadruple the number of nodes. The dashed horizontal arrows correspond to concatenation operations, where the output of a convolutional layer L.2, L.5, L.8 of the downsampling branch of the U-net structure is used as additional inputs for a convolutional layer L.13, L.16, L.19 of the upsampling branch of the U-net structure. This additional input data is treated as additional channels in the input node layer for the convolutional layer L.13, L.16, L.19 of the upsampling branch.

In an embodiment, the model(s) are provided by or implemented with a neural network trained using deep learning. The network(s) may be defined as a plurality of sequential feature units or layers. Sequential is used to indicate the general flow of output feature values from one layer to input to a next layer. The information from the next layer is fed to a next layer, and so on until the final output. The layers may only feed forward or may be bi-directional, including some feedback to a previous layer. The nodes of each layer or unit may connect with all or only a sub-set of nodes of a previous and/or subsequent layer or unit. Skip connections may be used, such as a layer outputting to the sequentially next layer as well as other layers. Rather than pre-programming the features and trying to relate the features to attributes, the deep architecture is defined to learn the features at different levels of abstraction the input data. The features are learned to reconstruct lower level features (i.e., features at a more abstract or compressed level). For example, features for generating a fused image or higher resolution image are learned. For a next unit, features for reconstructing the features of the previous unit are learned, providing more abstraction. Each node of the unit represents a feature. Different units are provided for learning different features.

Various units or layers may be used, such as convolutional, pooling (e.g., max-pooling), deconvolutional, fully connected, or other types of layers. Within a unit or layer, any number of nodes is provided. For example, 100 nodes are provided. Later or subsequent units may have more, fewer, or the same number of nodes. In general, for convolution, subsequent units have more abstraction.

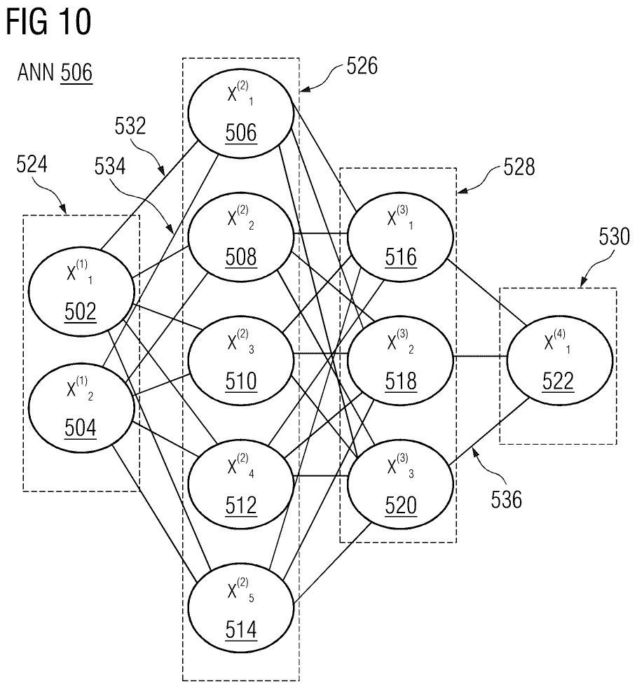

FIG. 10 shows an embodiment of an artificial neural network (ANN) 500, in accordance with one or more embodiments. Alternative terms for “artificial neural network” are “neural network”, “artificial neural net” or “neural net”. The artificial neural network 500 may be used in part in, for example, the one or more machine learning based networks utilized for the PnP model, etc.

The artificial neural network 500 includes nodes 502-522 and edges 532, 534, . . . , 536, wherein each edge 532, 534, . . . , 536 is a directed connection from a first node 502-522 to a second node 502-522. In general, the first node 502-522 and the second node 502-522 are different nodes 502-522, it is also possible that the first node 502-522 and the second node 502-522 are identical. For example, in FIG. 9, the edge 532 is a directed connection from the node 502 to the node 506, and the edge 534 is a directed connection from the node 504 to the node 506. An edge 532, 534, . . . , 536 from a first node 502-522 to a second node 502-522 is also denoted as “ingoing edge” for the second node 502-522 and as “outgoing edge” for the first node 502-522.

In this embodiment, the nodes 502-522 of the artificial neural network 500 may be arranged in layers 524-530, wherein the layers may include an intrinsic order introduced by the edges 532, 534, . . . , 536 between the nodes 502-522. In particular, edges 532, 534, . . . , 536 may exist only between neighboring layers of nodes. In the embodiment shown in FIG. 9, there is an input layer 524 including only nodes 502 and 504 without an incoming edge, an output layer 530 including only node 522 without outgoing edges, and hidden layers 526, 528 in-between the input layer 524 and the output layer 530. In general, the number of hidden layers 526, 528 may be chosen arbitrarily. The number of nodes 502 and 504 within the input layer 524 usually relates to the number of input values of the neural network 500, and the number of nodes 522 within the output layer 530 usually relates to the number of output values of the neural network 500.

In particular, a (real) number may be assigned as a value to every node 502-522 of the neural network 500. Here, x⁽ⁿ⁾ᵢ denotes the value of the i-th node 502-522 of the n-th layer 524-530. The values of the nodes 502-522 of the input layer 524 are equivalent to the input values of the neural network 500, the value of the node 522 of the output layer 530 is equivalent to the output value of the neural network 500. Furthermore, each edge 532, 534, . . . , 536 may include a weight being a real number, in particular, the weight is a real number within the interval [−1, 1] or within the interval [0, 1]. Here, w^{(m,n)}_{i,j} denotes the weight of the edge between the i-th node 502-522 of the m-th layer 524-530 and the j-th node 502-522 of the n-th layer 524-530. Furthermore, the abbreviation w⁽ⁿ⁾_{i,j} is defined for the weight w^{(n,n+1)}_{i,j}.

In particular, to calculate the output values of the neural network 500, the input values are propagated through the neural network. In particular, the values of the nodes 502-522 of the (n+1)-th layer 524-530 may be calculated based on the values of the nodes 502-522 of the n-th layer 524-530 by

$${x}_{j}^{( n + 1 )} = f ( {\sum }_{i} {x}_{i}^{( n )} \cdot {w}_{i , j}^{( n )} ) .$$

Herein, the function f is a transfer function (another term is “activation function”). Known transfer functions are step functions, sigmoid function (e.g. the logistic function, the generalized logistic function, the hyperbolic tangent, the Arctangent function, the error function, the smoothstep function) or rectifier functions. The transfer function is mainly used for normalization purposes.

In particular, the values are propagated layer-wise through the neural network, wherein values of the input layer 524 are given by the input of the neural network 500, wherein values of the first hidden layer 526 may be calculated based on the values of the input layer 524 of the neural network, wherein values of the second hidden layer 528 may be calculated based in the values of the first hidden layer 526, etc.

In order to set the values w^{(m,n)}_{i,j} for the edges, the neural network 500 has to be trained using training data. In particular, training data includes training input data and training output data (denoted as tᵢ). For a training step, the neural network 500 is applied to the training input data to generate calculated output data. In particular, the training data and the calculated output data include a number of values, said number being equal with the number of nodes of the output layer.

In particular, a comparison between the calculated output data and the training data is used to recursively adapt the weights within the neural network 500 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δ⁽ⁿ⁾ⱼ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δ⁽ⁿ⁺¹⁾ⱼ, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 530, wherein f′ is the first derivative of the activation function, and y⁽ⁿ⁺¹⁾ⱼ is the comparison training value for the j-th node of the output layer 530.

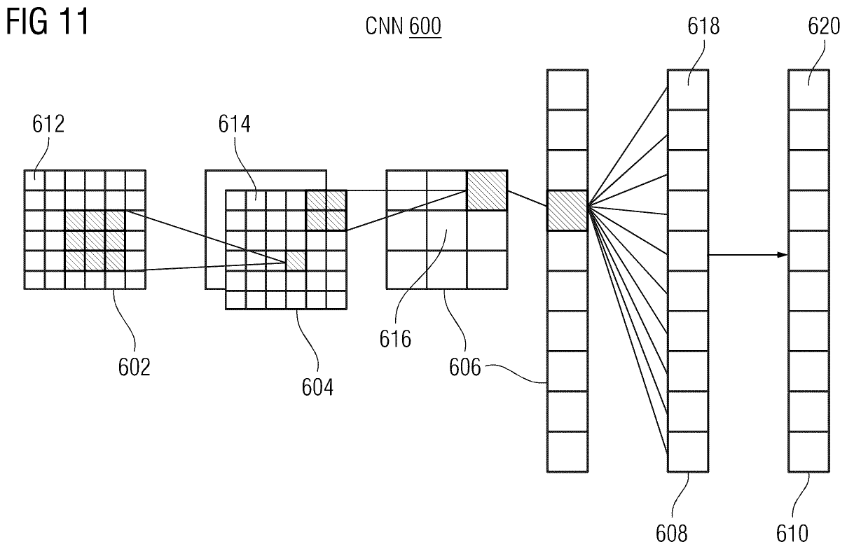

FIG. 11 shows a convolutional neural network (CNN) 600, in accordance with one or more embodiments. Machine learning networks described herein, such as, e.g., the PnP model etc. may be implemented using convolutional neural network 600.

In the embodiment shown in FIG. 11 the convolutional neural network includes 600 an input layer 602, a convolutional layer 604, a pooling layer 606, a fully connected layer 608, and an output layer 610. Alternatively, the convolutional neural network 600 may include several convolutional layers 604, several pooling layers 606, and several fully connected layers 608, as well as other types of layers. The order of the layers may be chosen arbitrarily, usually fully connected layers 608 are used as the last layers before the output layer 610.

In particular, within a convolutional neural network 600, the nodes 612-620 of one layer 602-610 may be considered to be arranged as a d-dimensional matrix or as a d-dimensional image. In particular, in the two-dimensional case the value of the node 612-620 indexed with i and j in the n-th layer 602-610 may be denoted as x⁽ⁿ⁾_{[i,j]}. However, the arrangement of the nodes 612-620 of one layer 602-610 does not have an effect on the calculations executed within the convolutional neural network 600 as such, since these are given solely by the structure and the weights of the edges.

In particular, a convolutional layer 604 is characterized by the structure and the weights of the incoming edges forming a convolution operation based on a certain number of kernels. In particular, the structure and the weights of the incoming edges are chosen such that the values x⁽ⁿ⁾ₖ of the nodes 614 of the convolutional layer 604 are calculated as a convolution x⁽ⁿ⁾ₖ=Kₖ*x⁽ⁿ⁻¹⁾ based on the values x⁽ⁿ⁻¹⁾ of the nodes 612 of the preceding layer 602, where the convolution * is defined in the two-dimensional case as:

$${x}_{k}^{( n )} [ i , j ] = ( {K}_{{k}^{*}} {x}^{( n - 1 )} ) [ i , j ] = {\sum }_{i} , {\sum }_{j} , {K}_{k} [ {i}^{′} , {j}^{′} ] \cdot {x}^{( n - 1 )} [ i - {i}^{′} , j - {j}^{′} ] .$$

Here the k-th kernel Kₖ is a d-dimensional matrix (in this embodiment a two-dimensional matrix), which is usually small compared to the number of nodes 612-618 (e.g. a 3×3 matrix, or a 5×5 matrix). In particular, this implies that the weights of the incoming edges are not independent, but chosen such that they produce said convolution equation. In particular, for a kernel being a 3×3 matrix, there are only 9 independent weights (each entry of the kernel matrix corresponding to one independent weight), irrespectively of the number of nodes 612-620 in the respective layer 602-610. In particular, for a convolutional layer 604, the number of nodes 614 in the convolutional layer is equivalent to the number of nodes 612 in the preceding layer 602 multiplied with the number of kernels.

If the nodes 612 of the preceding layer 602 are arranged as a d-dimensional matrix, using a plurality of kernels may be interpreted as adding a further dimension (denoted as “depth” dimension), so that the nodes 614 of the convolutional layer 604 are arranged as a (d+1)-dimensional matrix. If the nodes 612 of the preceding layer 602 are already arranged as a (d+1)-dimensional matrix including a depth dimension, using a plurality of kernels may be interpreted as expanding along the depth dimension, so that the nodes 614 of the convolutional layer 604 are arranged also as a (d+1)-dimensional matrix, wherein the size of the (d+1)-dimensional matrix with respect to the depth dimension is by a factor of the number of kernels larger than in the preceding layer 602.

The advantage of using convolutional layers 604 is that spatially local correlation of the input data may exploited by enforcing a local connectivity pattern between nodes of adjacent layers, in particular by each node being connected to only a small region of the nodes of the preceding layer.

In the embodiment shown in FIG. 11, the input layer 602 includes 36 nodes 612, arranged as a two-dimensional 6×6 matrix. The convolutional layer 604 includes 72 nodes 614, arranged as two two-dimensional 6×6 matrices, each of the two matrices being the result of a convolution of the values of the input layer with a kernel. Equivalently, the nodes 614 of the convolutional layer 604 may be interpreted as arranges as a three-dimensional 6×6×2 matrix, wherein the last dimension is the depth dimension.

A pooling layer 606 may be characterized by the structure and the weights of the incoming edges and the activation function of its nodes 616 forming a pooling operation based on a non-linear pooling function f. For example, in the two dimensional case the values x⁽ⁿ⁾ of the nodes 616 of the pooling layer 606 may be calculated based on the values x⁽ⁿ⁻¹⁾ of the nodes 614 of the preceding layer 604 as

$${x}^{( n )} [ i , j ] = f ( {x}^{( n - 1 )} [ {id}_{1} , {jd}_{2} ] , … , {x}^{( n - 1 )} [ i {d}_{1} + {d}_{1} - 1 , j {d}_{2} + {d}_{2} - 1 ] )$$

In other words, by using a pooling layer 606, the number of nodes 614, 616 may be reduced, by replacing a number d1·d2 of neighboring nodes 614 in the preceding layer 604 with a single node 616 being calculated as a function of the values of said number of neighboring nodes in the pooling layer. In particular, the pooling function f may be the max-function, the average, or the L2-Norm. In particular, for a pooling layer 606 the weights of the incoming edges are fixed and are not modified by training.

The advantage of using a pooling layer 606 is that the number of nodes 614, 616 and the number of parameters is reduced. This leads to the amount of computation in the network being reduced and to a control of overfitting.

In the embodiment shown in FIG. 11, the pooling layer 606 is a max-pooling, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 9.

A fully-connected layer 608 may be characterized by the fact that a majority, in particular, all edges between nodes 616 of the previous layer 606 and the nodes 618 of the fully-connected layer 608 are present, and wherein the weight of each of the edges may be adjusted individually.

In this embodiment, the nodes 616 of the preceding layer 606 of the fully-connected layer 608 are displayed both as two-dimensional matrices, and additionally as non-related nodes (indicated as a line of nodes, wherein the number of nodes was reduced for a better presentability). In this embodiment, the number of nodes 618 in the fully connected layer 608 is equal to the number of nodes 616 in the preceding layer 606. Alternatively, the number of nodes 616, 618 may differ.

A convolutional neural network 600 may also include a ReLU (rectified linear units) layer or activation layers with non-linear transfer functions. In particular, the number of nodes and the structure of the nodes contained in a ReLU layer is equivalent to the number of nodes and the structure of the nodes contained in the preceding layer. In particular, the value of each node in the ReLU layer is calculated by applying a rectifying function to the value of the corresponding node of the preceding layer.

The input and output of different convolutional neural network blocks may be wired using summation (residual/dense neural networks), element-wise multiplication (attention) or other differentiable operators. Therefore, the convolutional neural network architecture may be nested rather than being sequential if the whole pipeline is differentiable.

In particular, convolutional neural networks 600 may be trained based on the backpropagation algorithm. For preventing overfitting, methods of regularization may be used, e.g. dropout of nodes 612-620, stochastic pooling, use of artificial data, weight decay based on the L1 or the L2 norm, or max norm constraints. Different loss functions may be combined for training the same neural network to reflect the joint training objectives. A subset of the neural network parameters may be excluded from optimization to retain the weights pretrained on another datasets.

The success of patch-based inference hinges on effectively training generalized diffusion priors capable of accurately modeling complex image structures at a local scale. By efficiently applying these priors through small patches, the overall reconstruction becomes more computationally feasible, maintains high quality, and remains suitable for high-resolution images commonly found in medical imaging contexts like MRI or CT scans.

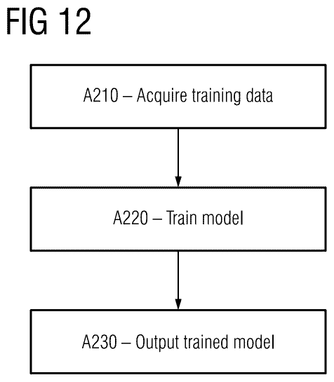

FIG. 12 depicts an example method for training a PnP diffusion model. In an embodiment, the PnP model is a trained neural network. In an embodiment, the network is trained to learn the inverse diffusion process, for example to progressively recover clean images from noisy versions. The training of the network may be performed at any point prior to application. The training process starts with a dataset of high-quality images that are systematically corrupted by adding noise through a series of time steps. The goal of training is to teach the model to reverse this degradation and reconstruct the original images with high fidelity. In an embodiment, the training phase follows a modified diffusion framework where the model learns to predict the noise at each step, conditioned on the noisy input. The model is trained using a loss function, for example a mean squared error (MSE) between the predicted and true noise components, ensuring that the model accurately estimates the noise distribution. By minimizing this loss across multiple training examples, the model refines its ability to denoise images across different levels of corruption. The training involves optimizing an objective function, reminiscent of traditional denoising methods, which seeks to minimize the difference between the observed noisy image and the predicted clean image, adjusted by a prior (\phi(x)) that functions as a denoiser. The authors emphasize the potential of using a single broadly trained model to tackle multiple tasks, thereby avoiding the pitfalls of overfitting to narrow anatomical features.

At act A210, training data is acquired. The training data may include a dataset of medical image data that represents multiple different styles and subject matter. In an embodiment, a single diffusion prior was trained on a diverse dataset comprising approximately 289,000 MRI images from various anatomical regions, including the brain, knee, and prostate. This approach contrasts with previous studies that often used anatomically specific priors. The generalized prior enables the model to be applicable across multiple inverse problems without being limited to specific anatomical structures. Alternatively the network may be trained using the style and subject matter that the diffusion model is configured to generate. Different sets of training data may be used for different models that are used for different purposes. For example, training data of the knee may be used to train a model for generating knee images, while training data of the brain may be used to train a model for generating brain images.

At act A220, a model to estimate a MR image is trained by finding the reverse transitions that maximize the likelihood of the training data. In an embodiment, the model is a generative model, in particular a diffusion model, for example, a DDPM or DDIM. In the learning phase, the forward process 210 learns the probability density function of MR image data by adding noise to the input image data. In the reverse process 210, an image is synthesized using the learned probability density function of MR image data. In the reverse process, a data consistency term G is used. G may include measurements/linear transform of known features of the region or objects being scanned. In an embodiment, a regularization term may be included such as subspace approaches, MP, PCA etc. on the sequence of MR images.

In an embodiment, the model is not trained patch-wise. Alternatively, the model may be trained with whole images (256×256), as well as with randomly sampled patches of size 128×128. A patch-wise trained prior offers comparable performance to a model trained at full image size. Specifically, when the model is trained with patch size 128×128 are used in whole image mode for plug-and-play, their performance is comparable to the whole image trained model. While patch-based inference may be applied regardless of training, models trained with randomly sampled patches are slightly more resilient to changing patch sizes during inference.

Different training mechanisms may be used, such as reparameterization or score-based generative modeling. In an embodiment, the model is based on is a convolutional neural network, in particular, a convolutional neural network having a U-net structure, for example as displayed in FIG. 8. At act A230, the trained model for denoising the MR image is output. The model may be applied to newly acquired MRI data in order to generate MR image data.

In an example application of the trained model, for the inference process, the application uses a shifted-grid 301 approach. This technique involves processing overlapping patches of the image to mitigate artifacts that can occur at the boundaries when patches are naively stitched together. For example, at least some patches from a first set from a first grid overlap at least partially with patches from a second set of patches from a second grid. The shifted-grid 301 method enhances the seamless integration of patches, thereby improving the quality of the reconstructed images. Reflection-padding is also used instead of zero-padding to avoid artifacts, resulting in cleaner and more accurate image reconstructions. One of the significant advantages of patch-based inference is the reduction in memory usage. Embodiments provide up to a 25% decrease in memory consumption when using 128×128 patches compared to processing whole images of size 320×320.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description. Independent of the grammatical term usage, individuals with male, female or other gender identities are included within the term.

The following is a list of non-limiting illustrative embodiments disclosed herein:

Illustrative embodiment 1: A method for image reconstruction of medical imaging data, the method comprising: acquiring a medical image of a patient; iteratively refining the medical image using a diffusion PnP model comprising a plurality of iterations, wherein for each iteration of the plurality of iterations, predictions for the medical image occur on a set of patches sampled from a grid of the medical image; and outputting the refined medical image.

Illustrative embodiment 2. The method of illustrative embodiment 1, wherein the patches are sampled using shifting-grid-based patch sampling to resolve grid artifacts.

Illustrative embodiment 3. The method of illustrative embodiment 1, wherein reflection padding is used on the patches sampled from the grid to eliminate foreground-to-padded-background transitions.

Illustrative embodiment 4. The method of illustrative embodiment 1, wherein the diffusion PnP model comprises DIFFPnP.

Illustrative embodiment 5. The method of illustrative embodiment 1, wherein each of the patches of the set of patches are 128×128 pixels in size.

Illustrative embodiment 6. The method of illustrative embodiment 1, wherein the medical image is acquires using magnetic resonance imaging (MRI), computed tomography (CT), photon counting CT (PCCT), ultra-high-resolution CT (UHR PCCT), or spectral CT.

Illustrative embodiment 7. The method of illustrative embodiment 1, wherein the diffusion PnP model is trained using a dataset of medical images comprising MRI scans sourced from multiple anatomical regions including at least brain, knee, and prostate regions.

Illustrative embodiment 8. The method of illustrative embodiment 1, wherein the diffusion PnP model uses measurement data for regularization.

Illustrative embodiment 9. The method of illustrative embodiment 1, wherein the patches are sampled by: dividing the medical image into a plurality of patches, wherein each patch of the plurality of patches undergoes independent inference by leveraging a trained generalized diffusion prior, wherein multiple inference passes are conducted with systematically shifted patch grids, wherein reflection padding is used to mirrors pixel values at boundaries of the medical image.

Illustrative embodiment 10. A system for image reconstruction of medical imaging data, the system comprising: a medical imaging system configured to acquire medical imaging data; a diffusion PnP model configured to use patch-based sampling to reconstruct a medical image from the medical imaging data, wherein instead of predicting an entire denoised image, predictions occur on foreground patches sampled from a grid; and an interface configured to display the medical image.

Illustrative embodiment 11. The system of illustrative embodiment 10, wherein the patch-based sampling uses shifting-grid-based patch sampling to resolve grid artifacts.

Illustrative embodiment 12. The system of illustrative embodiment 10, wherein reflection padding is used on patches sampled from the grid to eliminate foreground-to-padded-background transitions.

Illustrative embodiment 13. The system of illustrative embodiment 10, wherein the diffusion PnP model comprises DIFFPnP.

Illustrative embodiment 14. The system of illustrative embodiment 10, wherein patches of the patch-based sampling are 128×128 pixels in size.

Illustrative embodiment 15. The system of illustrative embodiment 10, wherein the medical imaging system comprises a magnetic resonance imaging system.

Illustrative embodiment 16. The system of illustrative embodiment 10, wherein the patch-based sampling comprises a plurality of patches created by dividing the medical imaging data using the grid; wherein each patch of the plurality of patches undergoes independent inference by leveraging a trained generalized diffusion prior, wherein at least one additional inference passes are conducted with the grid shifted, wherein reflection padding is used to mirrors pixel values at boundaries of the medical image.

Illustrative embodiment 17. The system of illustrative embodiment 10, wherein the diffusion PnP model is trained using a dataset of medical images comprising MRI scans sourced from multiple anatomical regions including at least brain, knee, and prostate regions.

Illustrative embodiment 18. A method for image reconstruction of a medical image, the method comprising: acquiring medical imaging data of a patient; iteratively refining the medical imaging data using a diffusion PnP model, wherein each iteration comprises: dividing the medical imaging data into a first set of patches using a first grid, wherein reflection padding mirrors pixel values at image boundaries of the medical image; performing inference on one or more patches from the first set using a trained generalized diffusion prior; dividing the medical imaging data into a second set of patches using a second grid, the second grid shifted from the first grid, wherein reflection padding mirrors pixel values at image boundaries of the medical image; performing inference on one or more patches from the second set using a trained generalized diffusion prior; reincorporating the medical imaging data from the one or more patches from the first set and the one or more patches from the second set for which inference was performed, the reincorporated medical imaging data uses to solve a data proximal subproblem for regularization; deriving a state for a next iteration by adding noise back; and outputting the refined medical imaging data.

Illustrative embodiment 19. The method of illustrative embodiment 18, wherein the medical imaging data is acquired using magnetic resonance imaging (MRI).

Illustrative embodiment 20. The method of illustrative embodiment 19, wherein the diffusion PnP model is trained using a dataset of medical images comprising MRI scans sourced from multiple anatomical regions including at least brain, knee, and prostate regions.

1. A method for image reconstruction of medical imaging data, the method comprising:
acquiring a medical image of a patient;
iteratively refining the medical image using a diffusion PnP model comprising a plurality of iterations, wherein for each iteration of the plurality of iterations, predictions for the medical image occur on a set of patches sampled from a grid of the medical image; and
outputting the refined medical image.

2. The method of claim 1, wherein the patches are sampled using shifting-grid-based patch sampling to resolve grid artifacts.

3. The method of claim 1, wherein reflection padding is used on the patches sampled from the grid to eliminate foreground-to-padded-background transitions.

4. The method of claim 1, wherein the diffusion PnP model comprises DIFFPnP.

5. The method of claim 1, wherein each of the patches of the set of patches are 128×128 pixels in size.

6. The method of claim 1, wherein the medical image is acquires using magnetic resonance imaging (MRI), computed tomography (CT), photon counting CT (PCCT), ultra-high-resolution CT (UHR PCCT), or spectral CT.

7. The method of claim 1, wherein the diffusion PnP model is trained using a dataset of medical images comprising MRI scans sourced from multiple anatomical regions including at least brain, knee, and prostate regions.

8. The method of claim 1, wherein the diffusion PnP model uses measurement data for regularization.

9. The method of claim 1, wherein the patches are sampled by:
dividing the medical image into a plurality of patches, wherein each patch of the plurality of patches undergoes independent inference by leveraging a trained generalized diffusion prior, wherein multiple inference passes are conducted with systematically shifted patch grids, wherein reflection padding is used to mirrors pixel values at boundaries of the medical image.

10. A system for image reconstruction of medical imaging data, the system comprising:
a medical imaging system configured to acquire medical imaging data;
a diffusion PnP model configured to use patch-based sampling to reconstruct a medical image from the medical imaging data, wherein instead of predicting an entire denoised image, predictions occur on foreground patches sampled from a grid; and
an interface configured to display the medical image.

11. The system of claim 10, wherein the patch-based sampling uses shifting-grid-based patch sampling to resolve grid artifacts.

12. The system of claim 10, wherein reflection padding is used on patches sampled from the grid to eliminate foreground-to-padded-background transitions.

13. The system of claim 10, wherein the diffusion PnP model comprises DIFFPnP.

14. The system of claim 10, wherein patches of the patch-based sampling are 128×128 pixels in size.

15. The system of claim 10, wherein the medical imaging system comprises a magnetic resonance imaging system.

16. The system of claim 10, wherein the patch-based sampling comprises a plurality of patches created by dividing the medical imaging data using the grid; wherein each patch of the plurality of patches undergoes independent inference by leveraging a trained generalized diffusion prior, wherein at least one additional inference passes are conducted with the grid shifted, wherein reflection padding is used to mirrors pixel values at boundaries of the medical image.

17. The system of claim 10, wherein the diffusion PnP model is trained using a dataset of medical images comprising MRI scans sourced from multiple anatomical regions including at least brain, knee, and prostate regions.

18. A method for image reconstruction of a medical image, the method comprising:
acquiring medical imaging data of a patient;
iteratively refining the medical imaging data using a diffusion PnP model, wherein each iteration comprises:
dividing the medical imaging data into a first set of patches using a first grid, wherein reflection padding mirrors pixel values at image boundaries of the medical image;
performing inference on one or more patches from the first set using a trained generalized diffusion prior;
dividing the medical imaging data into a second set of patches using a second grid, the second grid shifted from the first grid, wherein reflection padding mirrors pixel values at image boundaries of the medical image;
performing inference on one or more patches from the second set using a trained generalized diffusion prior;
reincorporating the medical imaging data from the one or more patches from the first set and the one or more patches from the second set for which inference was performed, the reincorporated medical imaging data uses to solve a data proximal subproblem for regularization;
deriving a state for a next iteration by adding noise back; and
outputting the refined medical imaging data.

19. The method of claim 18, wherein the medical imaging data is acquired using magnetic resonance imaging (MRI).

20. The method of claim 19, wherein the diffusion PnP model is trained using a dataset of medical images comprising MRI scans sourced from multiple anatomical regions including at least brain, knee, and prostate regions.
